(19) United States
(12) Patent Application Publication
(10) Pub. No.: US 2014/0379323 A1
(43) Pub. Date: Dec. 25, 2014

(54) ACTIVE LEARNING USING DIFFERENT KNOWLEDGE SOURCES

(71) Applicant: Microsoft Corporation, Redmond, WA (US)

(72) Inventors: Tasos Anastasakos, San Jose, CA (US); Ruhi Sarikaya, Redmond, WA (US); Daniel Boies, St. Lambert (CA); Larry Heck, Los Altos, CA (US)

(21) Appl. No.: 13/922,518

(22) Filed: Jun. 20, 2013

(51) Int. Cl. G06F 17/28

(52) U.S. Cl. CPC G06F 17/28
USPC 704/9

(57) ABSTRACT

Different knowledge sources are automatically accessed to identify and obtain additional data to update a conversational dialog system. One of the knowledge sources is initially selected as a seed source. Seed data from the seed source are used to identify related data in at least one other knowledge source. For example, query click logs may be accessed and searched to determine popular queries that use the seed data. A structured knowledge source may be accessed to determine related nodes to the seed data. A query click log, or some other knowledge source, may be used to determine when a node is related to the seed data. Data that is identified to be related may be used to train a language understanding model or update a schema for the SLU system. The data may be automatically annotated or manually annotated.

### BACKGROUND

Designing and training computing machines used in spoken language understanding systems typically requires a large amount of human effort. Typically a system requires a large amount of domain and task specific data that needs to be annotated, labeled and transcribed in order to be used for training and building models. This can be an expensive and laborious process. Active learning techniques are directed at improving a performance of these systems in a shorter time frame and with less cost as compared to traditional training methods.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Different knowledge sources are automatically accessed to identify and obtain additional data in an attempt to increase the accuracy of a conversational dialog system and to have better coverage for the system. The knowledge sources that are accessed may include a variety of different knowledge sources, such as, but not limited to: structured knowledge sources (e.g., semantic knowledge graphs, relational databases . . . ), query click logs, example queries for the dialog system, search results, schemas (e.g., a schema for the dialog system), and the like. One of the knowledge sources is initially selected as a seed source. Seed data from the seed source are used to identify related data in at least one other knowledge source. For example, query click logs may be accessed and searched to determine popular queries that use the seed data. A structured knowledge source may be accessed to determine related nodes to the seed data. The related data may be one or more hops away from a node identified by the seed data. For example, instead of a node being directly connected to the seed data, the node may be several hops away. A query click log, or some other knowledge source, may be used to determine when a node is related to the seed data. Data that is identified to be related may be used to train a language understanding model or update a schema for the dialog system. The data may be automatically annotated or manually annotated.

### BRIEF DESCRIPTION OF THE DRAWINGS

FIG. 1 shows a conversational dialog system using active learning from different knowledge sources;

FIG. 2 illustrates an exemplary web page that may include related data that may be used to update a conversational dialog system;

FIG. 3 illustrates an example Resource Description Framework segment;

FIG. 4 shows a semantically structured knowledge-base in graph form;

FIG. 5 illustrates a process for active learning using different knowledge sources;

FIG. 6 illustrates an exemplary online system that updates a language understanding model using data obtained from different knowledge sources; and

FIGS. 7, 8A, 8B and 9 and the associated descriptions provide a discussion of a variety of operating environments in which embodiments of the invention may be practiced.

### DETAILED DESCRIPTION

Referring now to the drawings, in which like numerals represent like elements, various embodiment will be described.

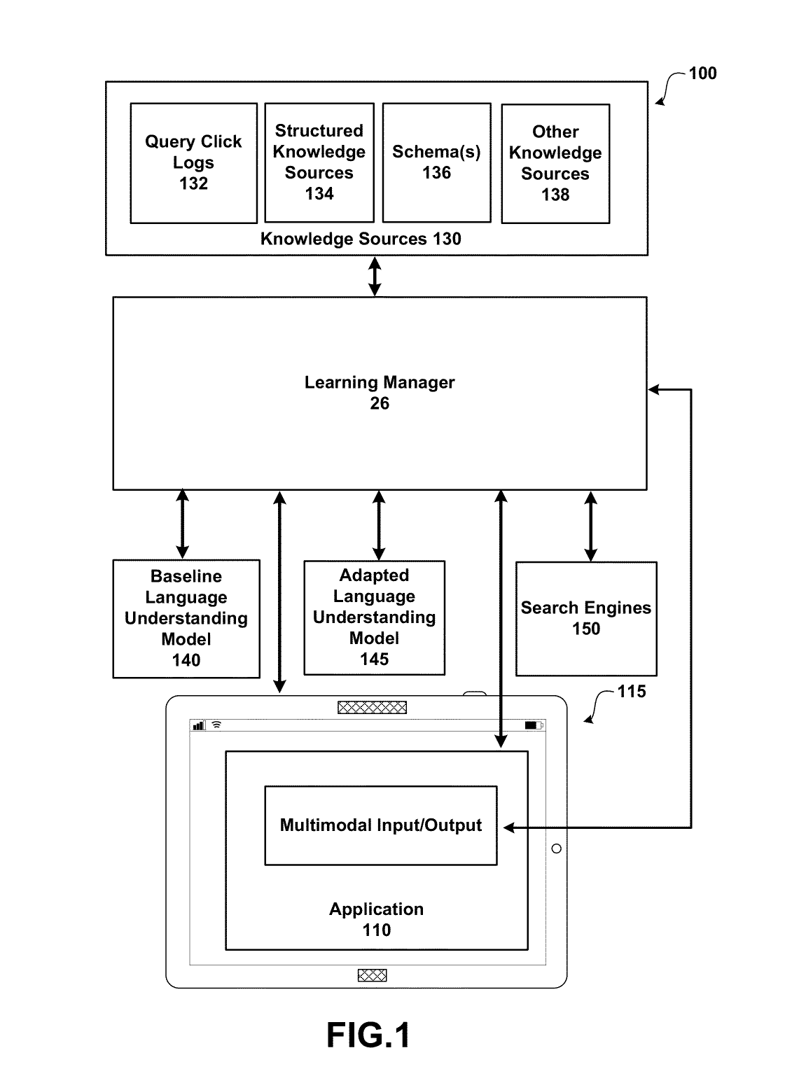

FIG. 1 shows a conversational dialog system using active learning from different knowledge sources. As illustrated, system 100 includes learning manager 26, knowledge sources 130, baseline language understanding model 140, adapted language understanding model 145, search engines 150, application 110 and touch screen input device/display 115.

A natural user interface (NUI) and/or some other interfaces may be used to interact with system 100. For example, application 110 may use a combination of a natural language dialog and other non-verbal modalities of expressing intent (gestures, touch, gaze, images/videos, spoken prosody, etc.) to interact with the conversational dialog system.

Learning manager 26 may use a language understanding model, such as baseline language understanding model 140 or adapted language understanding model 145. Generally, a language understanding model includes statistical information that is used to determine a meaning of a user input (e.g., utterance). Learning manager 26 may be part of a conversational dialog system that receives speech utterances and is configured to determine the meaning conveyed by a received utterance. According to an embodiment, learning manager 26 is part of an online service (e.g., “cloud” service) that provides conversational dialog services.

Generally, Language Understanding (LU) in goal-oriented dialog systems is directed at identifying the domain(s) and intent(s) of the user, as expressed in natural language (NL), and to extract associated arguments or slots. For example, in an airline domain, users often request flight information (e.g., “I want to fly to Boston from New York next week”). In many instances the slots are specific to the target domain and finding target values within automatically recognized spoken utterances can be challenging due to automatic speech recognition errors and poor modeling of natural language variability. Different classification methods may be used for filling frame slots from the application domain using a given training data set and performed comparative experiments. These methods generally use generative models such as hidden Markov models, discriminative classification methods and probabilistic context free grammars.

Some LU models may be trained using supervised machine learning methods. These models use a large number of in-domain sentences which are semantically annotated by humans. This can be a very expensive and time consuming process.

Learning manager 26 accesses different knowledge sources 130 to identify and obtain additional data to use in system 100. The different knowledge sources 130 may include knowledge sources, such as, but not limited to: query click logs 132, structured knowledge sources 134 (e.g., semantic knowledge graphs, relational databases . . . ), schemas 136 (e.g., a schema for system 100), and other knowledge sources 138 (e.g., example queries for system 100, search results, and the like).

Learning manager 26 selects one of the knowledge sources 130 as a seed knowledge source. The selection may occur automatically or manually. For example, a user may select the seed knowledge source or learning manager may select a knowledge source that is currently used by conversational understanding system 100 (e.g., training data, a schema . . . ). Seed data that is obtained from the seed knowledge source is used by learning manager 26 to locate related data from one or more of the other knowledge sources. The seed data may be all or a portion of the data in the seed knowledge source.

For example, in the movie domain the seed data may include movie names, actors, directors, and the like. In a music domain, the seed data may include musicians, albums, concerts, and the like. According to an embodiment, the knowledge source that acts as a seed knowledge source is a knowledge source that is associated with a baseline conversational dialog system (e.g., the initial schema, training data used to train baseline language understanding model 140, example utterances to interact with the system, and the like).

Query click logs 132 may be accessed and searched by learning manager 26 to determine queries that use the seed data. Query click logs 132 are logs that record user clicks that are associated with results of past searches. Users of web search engines (e.g., search engines 150 provide information about entities in the course of typical search sessions by clicking on relevant websites, and this is recorded in search engine logs.

Learning manager 26 automatically mines the query click logs 132 to discover related data that may be used to update the dialog system (e.g., training adapted language understanding model 145). Query click logs 132 that are obtained from web search engines 150 (e.g., MICROSOFT BING, GOOGLE . . . ) implicitly encode information that learning manager 26 automatically extracts and processes to determine related data.

Query click logs 132 may identify related data that is commonly used when a user submits a query using the seed data. For example, when the seed data is “movie”, the query click log 132 may identify other common terms used with “movie” (e.g., a time, a movie trailer, actors, directors, locations, directions, ratings, and the like). Other terms from the seed data may identify other related terms and queries. Learning manager 26 may be configured to locate all or a portion of the queries that include the term(s) that are identified by the seed data. For example, learning manager 26 may be configured to identify the top 80% of queries that include the term(s) that are identified by the seed data. Other percentages or methods may be used to determine related terms that may be used in system 100. The related data that is determined from the query click logs 132 may be used to update (e.g. train adapted understanding language model 140 or update a schema) the conversational dialog system. The related data that is determined from the query click logs 132 may also be used to locate additional related data (e.g., from other knowledge sources).

Learning manager 26 is configured to access structured content (e.g., structured knowledge sources 134) that includes related entities (e.g., structured web pages, relational database(s) . . . ). For example, learning manager 26 may access a structured knowledge source (e.g., a graph of related entities, a relational database, or some other structured knowledge source) to determine related nodes to the seed data. The structured content that is initially accessed may be based on a type of information to learn. For example, movie web site(s) may be accessed for information relating to a movie domain, music web site(s) may be accessed for information relating to a music domain, sport web site(s) may be accessed for information relating to a sport domain, and the like. Structured content in other domains may also be accessed.

The related data may be one or more hops away from a node identified by the seed data. For example, instead of being one hop from a node that is identified by the seed data, the node may be several hops away. A query click log, or some other knowledge source (e.g., documents, search results), may be used to determine when a node in the structured knowledge source is related to the seed data. For example, queries may be automatically created using different node combinations and searched using search engines 150 to determine whether or not the different combinations are related. A popularity of the search query may also be used to determine whether or not the combinations are related. A determination may also be made as to how often results from the queries are selected. For example, some combinations of the seed data and a possible related data may result in thousands of results that are commonly searched for together whereas another combination may result in just a few results. The popularity and the number of results may be used by learning manager 26 to automatically select the combination as being related.

Given the breadth of available structured content (e.g., semantic graphs such as Freebase), the coverage of domains, intents, and slots of a conversational dialog system may be extended automatically by locating related data. For example, each branch of a semantic graph may provide additional coverage for system 100, and learning manager 26 may crawl through one or more graphs until the structured content is traversed. The structured content may be publicly available or may be private structured content (e.g., structured content created by MICROSOFT, GOOGLE, APPLE . . . ).

Learning manager 26 may perform a search using one or more search engines 150 to determine other data that is related to the seed data. For example, learning manager 26 may perform a search using all/portion of the named entities in the seed knowledge source to determine related data.

Learning manager 26 may also use the schema as a seed knowledge source or access other schemas to determine if there are other related data used by other conversational dialog systems. The schema defines slots and attributes for the slots. For example, slots in a travel system may include destination city, departure day, departure date, departure time. Learning manager 26 may also access other knowledge sources 138.

After identifying the related data, learning manager 26 may use the related data to create or train an adapted language understanding model 145 and update the schema that is associated with conversational dialog system 100. The related data may be automatically annotated or manually annotated. For example, information from a structured knowledge source may be used to automatically annotate the data. Example queries may be used to create utterances used to create the adapted language understanding model. All or a portion of the related data that is identified may be used as training data for adapted language understanding model 145.

In order to facilitate communication with the learning manager 26, one or more callback routines, may be implemented. According to one embodiment, application program 110 is a multimodal application that is configured to receive speech input and input from a touch-sensitive input device 115 and/or other input devices. For example, voice input, keyboard input (e.g., a physical keyboard and/or SIP), video based input, and the like. Application program 110 may also provide multimodal output (e.g., speech, graphics, vibrations, sounds . . . ). Learning manager 26 may provide information to/from application 110 in response to user input (e.g., speech/gesture). For example, a user may say a phrase to identify a task to perform by application 110 (e.g., selecting a movie, buying an item, identifying a product . . . ). Gestures may include, but are not limited to: a pinch gesture; a stretch gesture; a select gesture (e.g., a tap action on a displayed element); a select and hold gesture (e.g., a tap and hold gesture received on a displayed element); a swiping action and/or dragging action; and the like. System 100 as illustrated comprises a touch screen input device/display 115 that detects when a touch input has been received (e.g., a finger touching or nearly teaching the touch screen). Any type of touch screen may be utilized that detects a user's touch input. More details are provided below.

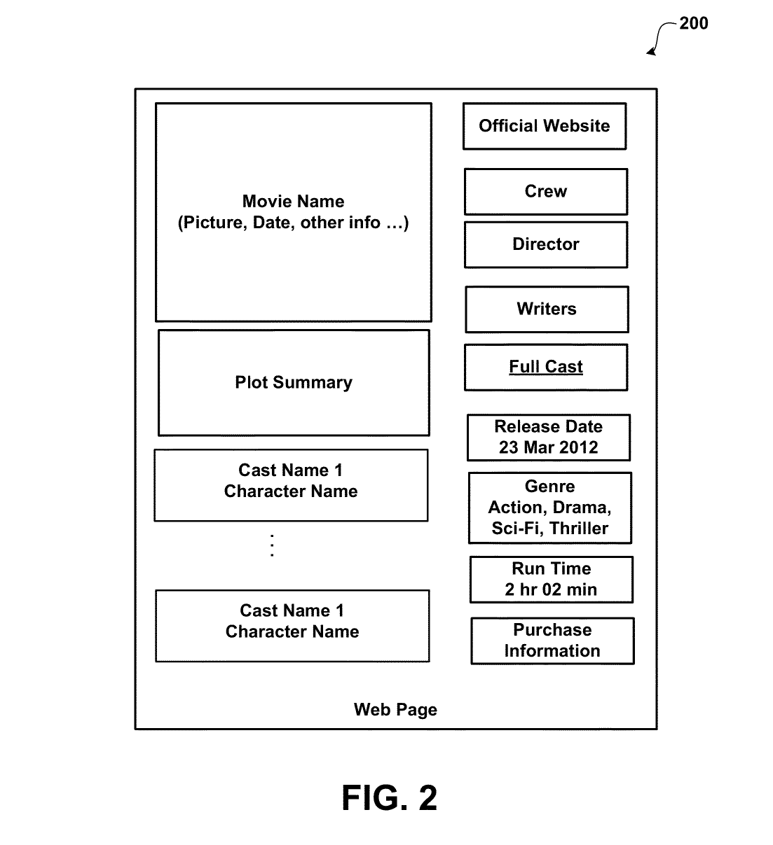

FIG. 2 illustrates an exemplary web page that may include related data that may be used to update a conversational dialog system.

Web pages may be used as a knowledge source. For example, when a conversational dialog system relates to movies, move web pages and pages relating to a movie may be accessed. For example, related content may be located by navigating links on the web page.

The information associated with a web page changes depending on the web site being accessed. In the example illustrated, web page 200 includes information related to a particular move and includes a movie name, a plot summary, cast names, crew names (e.g., director, writers), other crew (e.g., Full Cast), the release date, the genre, run-time, and purchase information. Information for other domains may be located using other web pages. Some of the accessed web pages may be structured that include entities that are defined by a relationship.

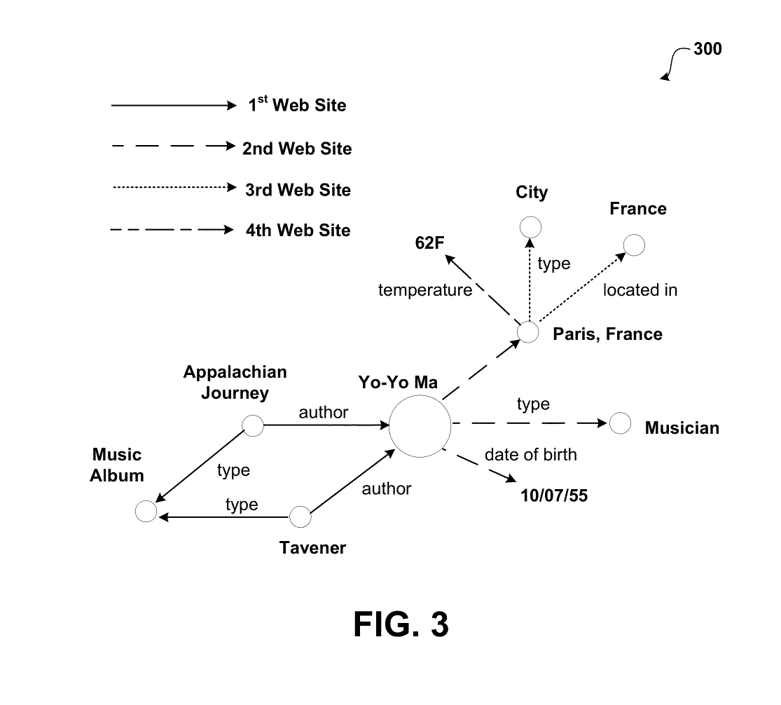

FIG. 3 illustrates an example Resource Description Framework segment.

A Resource Description Framework (RDF) is a triple-based representation for the semantic web. A triple typically consists of two entities linked by some relation. An example is: directed by (Avatar, James Cameron). As RDFs have become more popular, triple stores (referred to as knowledge-bases) covering various domains have emerged (e.g., freebase.org). Already defined ontologies may be extended or elements within one ontology may be used within another ontology. A commonly used ontology is provided in schema.org, with consensus from academia and major search companies like MICROSOFT and GOOGLE. While the structured content is illustrated within structured web pages, other structured content may be used (e.g., relational database(s)).

An example RDF segment 300 pertaining the artist Yo-Yo Ma is shown in FIG. 3. Viewing FIG. 3 it can be seen that Yo-Yo was born in Paris in 1955, and is an author of the music albums, Tavener and Appalachian Journey. The RDF segment illustrated in FIG. 3 includes information obtained from different web sites (e.g., web sites 1-4). These semantic ontologies are not only used by search engines, which try to semantically parse them, but also by the authors of these pages for better visibility. These kinds of semantic ontologies are similar to the semantic ontologies used in goal-oriented natural dialog systems.

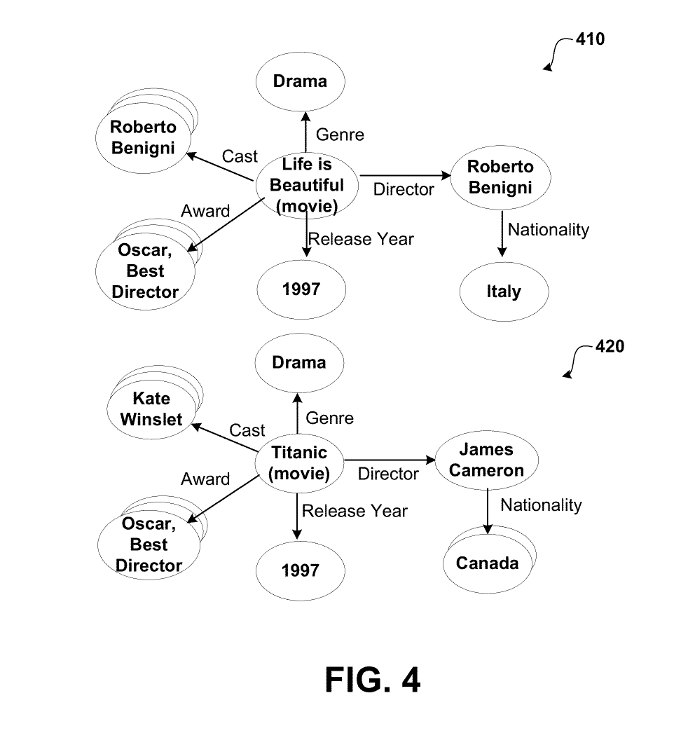

FIG. 4 shows a semantically structured knowledge-base in graph form.

Structured content sources (e.g., from the web or some other location) include entities (e.g., movies, organizations, restaurants, etc.) and their relations (e.g., director, founder, menu).

As illustrated, FIG. 4 includes branch 410 for the movie “Life is Beautiful” and branch 420 for the movie “Titanic.” The entities in the graphs are related to the other entities through links. For example, the genre for the “Life is Beautiful” entity is “Drama.” The entities in the graph may be parsed across many different nodes that are more than one hop away from a seed entity.

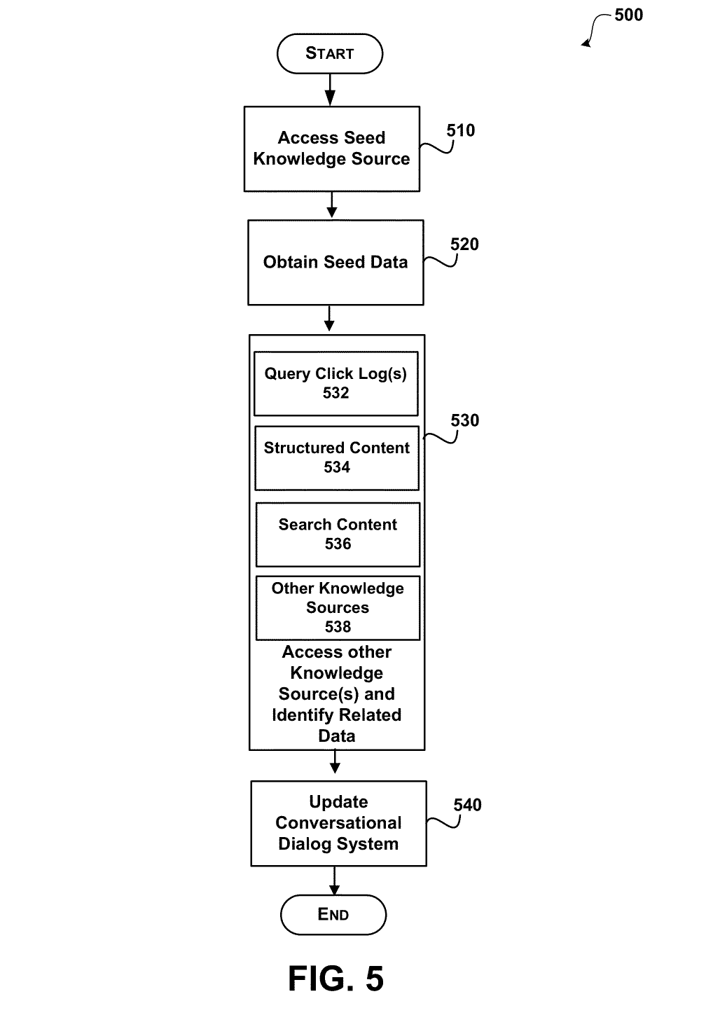

FIG. 5 illustrates a process for active learning using different knowledge sources. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, process 500 moves to operation 510, where a seed knowledge source is determined and accessed. The seed knowledge source may be one or more different knowledge sources. The different knowledge sources may include, but are not limited to: example queries, a schema for the conversational dialog system, query click logs, structured knowledge sources (e.g., semantic knowledge graphs, relational databases . . . ), as well as other knowledge sources (e.g., search results, web pages and the like). The selection may occur automatically or manually. For example, a user may select the seed knowledge source or a knowledge source may be selected that is predefined (e.g., training data, a schema . . . ).

Transitioning to operation 520, seed data is obtained from the seed knowledge source. The seed data is used to locate related content. All or a portion of the data in the seed knowledge source may be used to locate related data. For example, a first item in the seed knowledge source may be used to locate related data and then other items in the seed knowledge source may be used to locate related data.

Moving to operation 530, one or more other knowledge sources are accessed. As discussed, the other knowledge sources that are accessed may include many different types of knowledge sources.

At operation 532, query click logs may be accessed and searched for related data. The query click logs may be automatically mined to discover related data that may be used to update the dialog system (e.g., training an adapted language understanding model, updating a schema). For example, the related data may be identified from a top N % of popular queries that include the term(s) that are identified by the seed data.

At operation 534, structured content is accessed. The structured content comprises entities that are defined by a relationship (e.g., entity-relationship-entity, entity-relationship-entity-relationship-entity . . . ). The structured content may be in one or more forms (e.g., structured graph, structured web pages, relational databases, and the like). The structured content that is accessed may be based on a type of information to learn. According to an embodiment, a knowledge-graph may be accessed to obtain structured information. Generally, the nodes of the knowledge graphs are entities (person, place, or thing). The edges of the graph are relations between the entities. Data mining is automatically performed using the seed data to determine related entities from the structured content. For example, query click logs may be accessed to see what combinations of the seed data and the defined relationships within the structured content are popular.

At operation 536, search content is obtained to identify related data. Queries may be automatically formed using seed data and data from one or more knowledge sources. For example, queries may be formed using entities from the seed knowledge source and entities that are one or more hops from seed data. Given an entity in the knowledge structure (e.g., graph), web search queries are formed through a conjunction with the seed data and one or more entities. Forming the search queries continues for the all or a portion of the rest of the knowledge structure. According to an embodiment, web queries that are formed are executed by one or more web search engines (e.g., BING, GOOGLE, and the like).

According to an embodiment, a predetermined number of search results are used (e.g., the top-N most relevant documents received and ranked from a standard search engine) to determine related data. Other ranking may be used in combination or in separate from the received results. Search results may also be obtained from other search engines.

At operation 538, other knowledge sources may be accessed.

Flowing to operation 540, the related data that is identified from the other knowledge sources is used to update the conversational dialog system in an attempt to increase the coverage and understanding of the system. According to an embodiment, an understanding model (e.g., a language understanding model) is updated using the related data. According to another embodiment, a schema for the system is updated with the related data.

The process 500 described in FIG. 5 may be repeated using different seed knowledge sources and may be performed in different orders.

The process then flows to an end operation and returns to processing other actions.

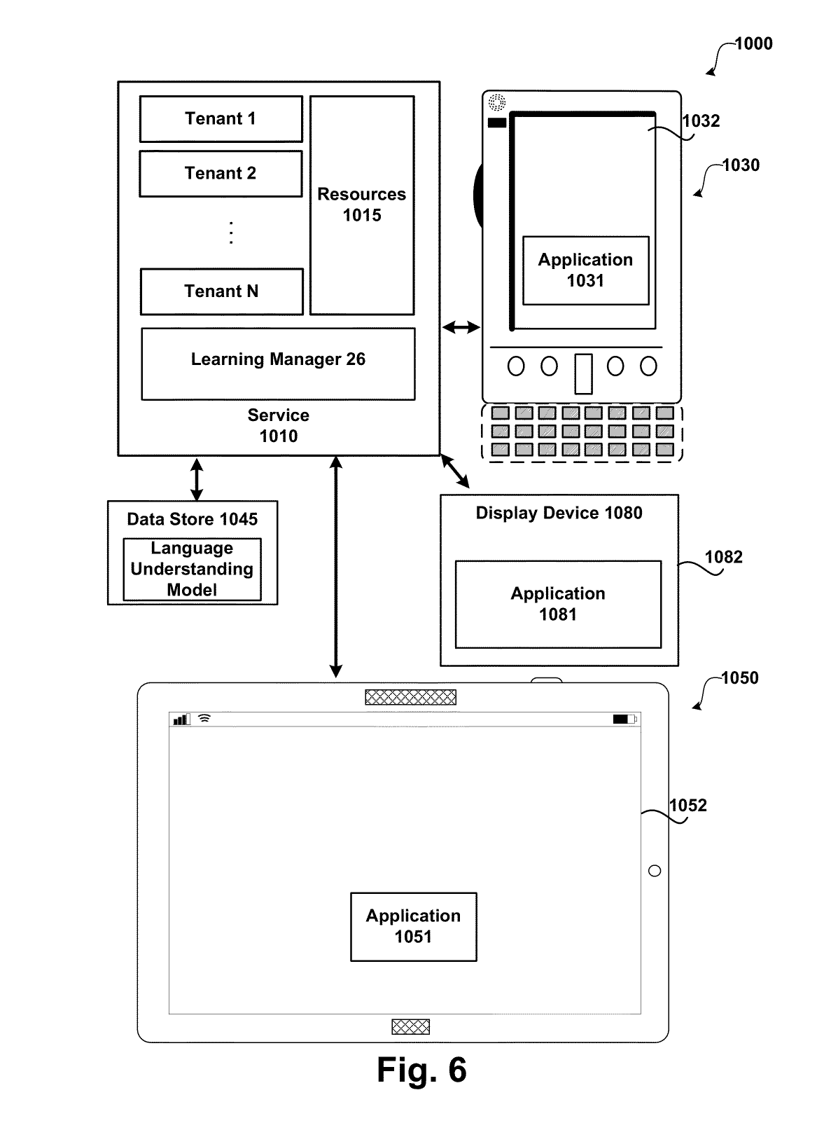

FIG. 6 illustrates an exemplary online system that updates a language understanding model using data obtained from different knowledge sources. As illustrated, system 1000 includes service 1010, data store 1045, touch screen input device 1050 (e.g., a slate), smart phone 1030 and display device 1080.

As illustrated, service 1010 is a cloud based and/or enterprise based service that may be configured to provide services, including a conversational dialog component, such as described herein. The service may be interacted with using different types of input/output. For example, a user may use speech input, touch input, hardware based input, and the like. Functionality of one or more of the services/applications provided by service 1010 may also be configured as a client/server based application.

As illustrated, service 1010 is a multi-tenant service that provides resources 1015 and services to any number of tenants (e.g., Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g., a slate/tablet device) and smart phone 1030 that detects when a touch input has been received (e.g., a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g., a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 are configured with multimodal input/output and each include an application (1031, 1051, 1081) that interact with learning manager 26.

As illustrated, touch screen input device 1050, smart phone 1030, and display device 1080 shows exemplary displays 1052/1032/1082 showing the use of an application. Data may be stored on a device (e.g., smart phone 1030, touch screen input device 1050 and/or at some other location (e.g., network data store 1045). Data store 1045, or some other store, may be used to store language understanding model, as well as other data. The applications used by the devices may be client based applications, server based applications, cloud based applications and/or some combination. According to an embodiment, display device 1080 is a device such as a MICROSOFT XBOX coupled to a display.

Learning manager 26 is configured to perform operations relating to processes as described herein. While manager 26 is shown within service 1010, the functionality of the manager may be included in other locations (e.g., on smart phone 1030 and/or touch screen input device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

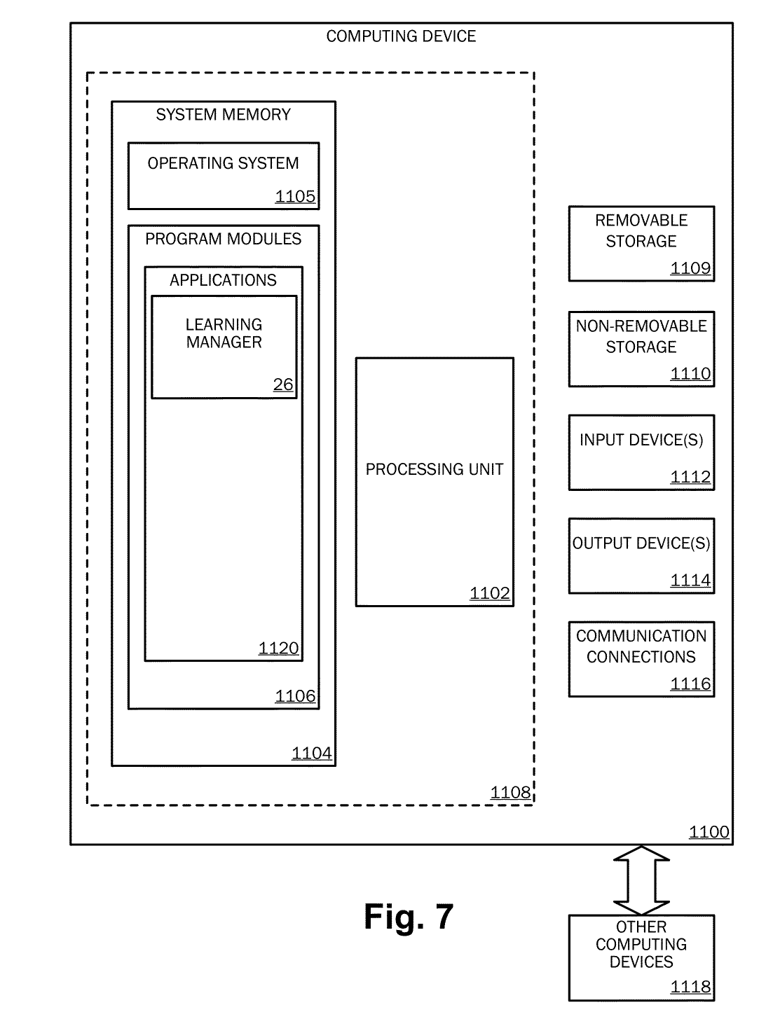

FIGS. 7-9 and the associated descriptions provide a discussion of a variety of operating environments in which embodiments of the invention may be practiced. However, the devices and systems illustrated and discussed with respect to FIGS. 7-9 are for purposes of example and illustration and are not limiting of a vast number of computing device configurations that may be utilized for practicing embodiments of the invention, described herein.

FIG. 7 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the learning manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 7 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 7 by a removable storage device 1109 and a non-removable storage device 1110.

As stated above, a number of program modules and data files may be stored in the system memory 1104. While executing on the processing unit 1102, the program modules 1106 (e.g., the learning manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the learning manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

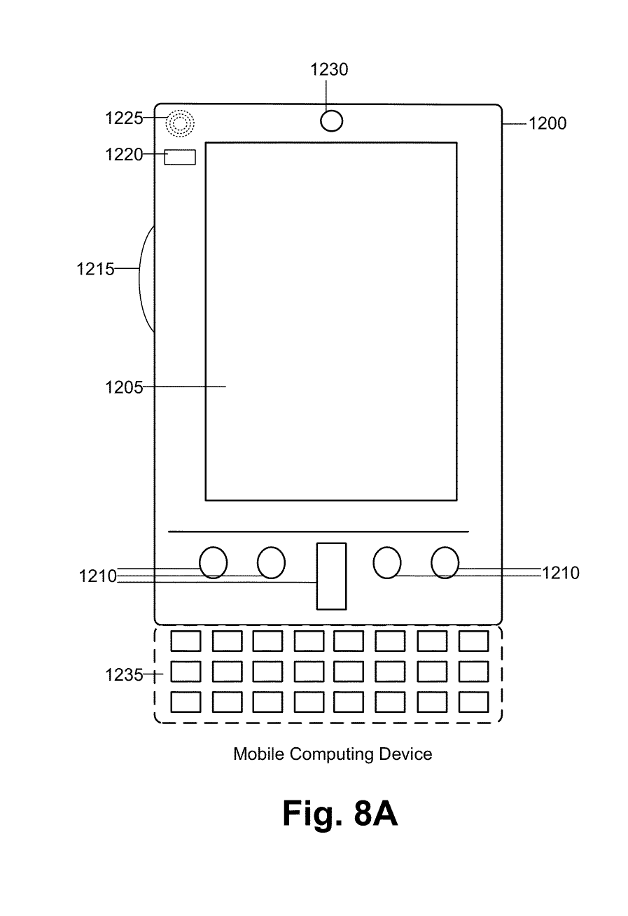

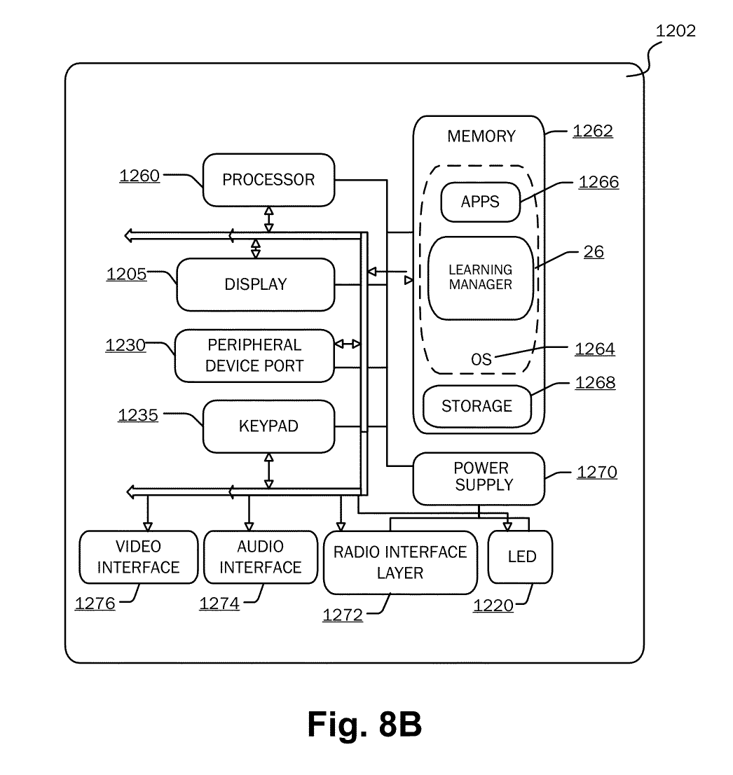

FIGS. 8A and 8B illustrate a mobile computing device 1200, for example, a mobile telephone, a smart phone, a tablet personal computer, a laptop computer, and the like, with which embodiments of the invention may be practiced. With reference to FIG. 8A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 1200 can incorporate a system 1202 (i.e., an architecture) to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the learning manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 8B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

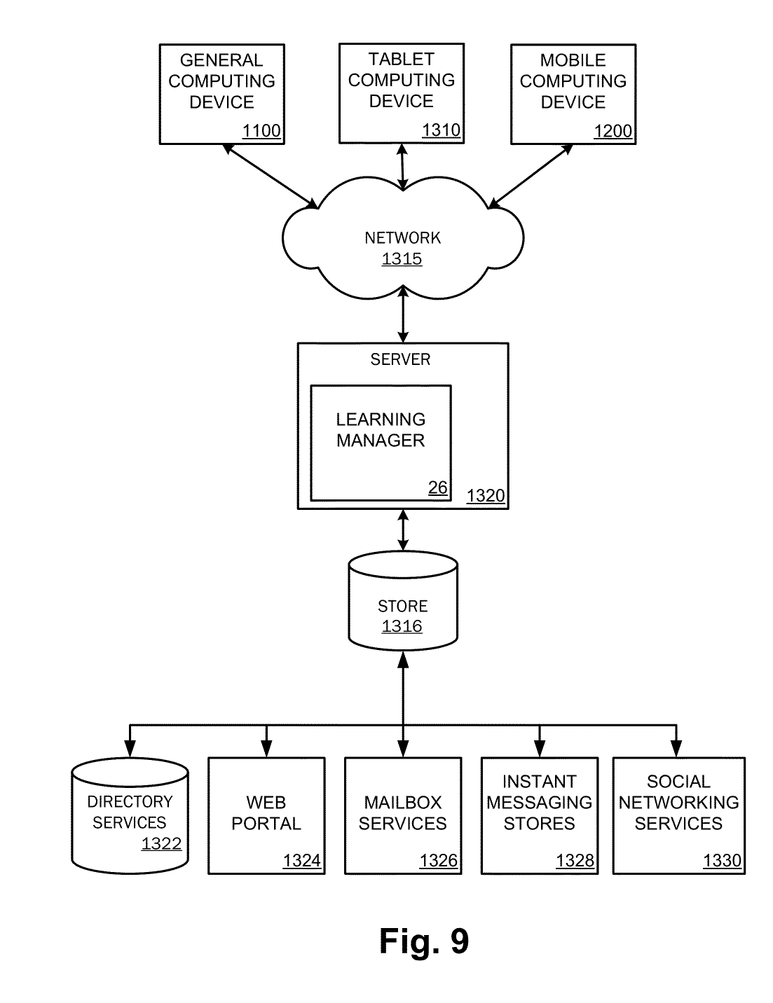

FIG. 9 illustrates an embodiment of an architecture of an exemplary system, as described above. Content developed, interacted with, or edited in association with the learning manager 26 may be stored in different communication channels or other storage types. For example, various documents may be stored using a directory service 1322, a web portal 1324, a mailbox service 1326, an instant messaging store 1328, or a social networking site 1330. The learning manager 26 may use any of these types of systems or the like for enabling data utilization, as described herein. A server 1320 may provide the learning manager 26 to clients. As one example, the server 1320 may be a web server providing the learning manager 26 over the web. The server 1320 may provide the learning manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, and 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for active learning using different knowledge sources, comprising:
accessing a seed knowledge source that includes data relating to a conversational dialog system;
automatically selecting seed data from the seed knowledge source;
accessing a second knowledge source that includes data relating to the conversational dialog system;
automatically identifying related data from the second knowledge source using the seed data; and
using the related data to update the conversational dialog system.

2. The method of claim 1, wherein accessing the seed knowledge source that includes data relating to the conversational dialog system comprises accessing at least one of: a schema for the conversational dialog system, training data for the conversational dialog system, or example utterances for the conversational dialog system.

3. The method of claim 1, wherein accessing the second knowledge source comprises accessing a structured knowledge source that includes entities that are defined by a relationship.

4. The method of claim 3, wherein accessing the structured content comprises accessing at least one of: a structured graph, a relational database, or a document.

5. The method of claim 1, wherein accessing the second knowledge source comprises accessing a query click log.

6. The method of claim 1, further comprising automatically creating queries using the seed data and data from the second knowledge source, executing the queries using a search engine, and receiving results from executing the queries.

7. The method of claim 1, wherein identifying the related data from the second knowledge source using the seed data comprises determining from a query click log other entities that are included with the seed data.

8. The method of claim 1, further comprising selecting popular queries that include the seed data from the second knowledge source.

9. The method of claim 1, wherein using the related data to update the conversational dialog system comprises updating at least one of: a schema of the conversational dialog system; or a language understanding model of the conversational dialog system.

10. A computer-readable medium storing computer-executable instructions for active learning using different knowledge sources for a conversational dialog system, comprising:
accessing a seed knowledge source from knowledge sources that includes data relating to the conversational dialog system;
automatically selecting seed data from the seed knowledge source;
accessing other knowledge sources;
identifying related data from the other knowledge source using the seed data; and
using the related data to update a language understanding model of the conversational dialog system.

11. The computer-readable medium of claim 10, wherein accessing the seed knowledge source that includes data relating to the conversational dialog system comprises accessing at least one of: a schema for the conversational dialog system, training data for the conversational dialog system, or example utterances for the conversational dialog system.

12. The computer-readable medium of claim 10, wherein accessing the other knowledge sources comprises accessing a structured knowledge source that includes entities that are defined by a relationship.

13. The computer-readable medium of claim 10, further comprising automatically creating queries using the seed data and data from the second knowledge source, executing the queries using a search engine, and receiving results from executing the queries.

14. The computer-readable medium of claim 10, wherein identifying the related data from the second knowledge source using the seed data comprises determining from a query click log other entities that are included with the seed data.

15. The computer-readable medium of claim 10, further comprising selecting popular queries that include the seed data.

16. The computer-readable medium of claim 10, wherein using the related data to update the language understanding model of the conversational dialog system further comprises updating a schema of the conversational dialog system.

17. A system for active learning using different knowledge sources for a conversational dialog system, comprising:
a processor and memory;
an operating environment executing using the processor; and
a learning manager that is configured to perform actions comprising:
accessing a seed knowledge source from knowledge sources including a structured knowledge source that includes data relating to the conversational dialog system;
automatically selecting seed data from the seed knowledge source;
accessing other knowledge sources;
identifying related data from the other knowledge source using the seed data; and
using the related data to update a language understanding model of the conversational dialog system.

18. The system of claim 17, wherein the knowledge sources comprise: a schema for the conversational dialog system, training data for the conversational dialog system, and search results.

19. The system of claim 17, further comprising automatically creating queries using the seed data and data from the second knowledge source, executing the queries using a search engine, and receiving results from executing the queries.

20. The system of claim 17, wherein identifying the related data from the second knowledge source using the seed data comprises determining from a query click log other entities that are included with the seed data.
